(19) United States
(12) Patent Application Publication
(10) Pub. No.: US 2016/0298712 A1
(43) Pub. Date: Oct. 13, 2016

(54) Rolling Piston

(71) Applicants: VIBRACOUSTIC CV AIR SPRINGS GMBH, Hamburg (DE); SAF-HOLLAND GMBH, Bessenbach (DE)

(72) Inventors: Michael Weber, Buchholz (DE); Stefan Fäth, Aschaffenburg (DE)

(73) Assignee: SAF-HOLLAND GmbH, Bessenbach (DE)

(21) Appl. No.: 15/101,755

(22) PCT Filed: Dec. 5, 2014
(86) PCT No.: PCT/EP2014/076754

§ 371 Date: Jun. 3, 2016

(30) Foreign Application Priority Data
Dec. 5, 2013 (DE) 10 2013 113 577.3

(51) Int. Cl. F16F 9/05; F16F 9/04

(52) U.S. Cl. CPC F16F 9/057; F16F 9/049

(57) ABSTRACT

The present invention relates to a rolling piston for an air spring damper in the field of commercial vehicles, having a piston section and a container section which are of hollow configuration and are connected to one another in a fluid-conducting manner, and a cover element, the cover element being connected to the container section, in order to form an additional volume container.

### BACKGROUND OF THE INVENTION

The present invention relates to a rolling piston for an air spring damper in the field of commercial vehicles. Furthermore, the invention relates to an air spring damper having a rolling piston of this type.

Air springs or rolling lobe springs serve to suspend two vehicle parts which are movable with respect to one another, but also to change the ride height position of a vehicle. Air springs of this type have an air spring bellows which is made from rubber and is connected to an upper terminating element, usually in the form of a plate, and a rolling piston, in order to form a working space which is closed in an airtight manner. During compression and rebound, the rolling lobe rolls on the outer face of the rolling piston. Furthermore, the attachment of the air spring to a vehicle part, such as a support arm or a link, takes place via the rolling piston.

In addition to the above-described suspension function, it is also possible to design an air spring in such a way that it additionally has a damping function. Air springs of this type are called air spring dampers (ASD). In an air spring damper, the damping takes place by virtue of the fact that a fluid flows to and fro via a constricted cross section between the working space and a chamber which is configured in the rolling piston. On account of the constricted cross section and the associated friction, the vibrations which are introduced are damped. In addition, the cross section can be capable of being opened and closed by means of a valve. By way of this, the damping function can be switched on and off or the damping characteristic can be changed.

The damping behavior of an air spring damper of this type is dependent on the air volume which is available. In order to increase the volume, it is known to connect the working space to an additional volume in the form of a separate container.

For instance, an air spring damper, the rolling piston of which is connected to an additional volume container via a connecting duct, is apparent from DE 10 2004 011 466 A1. In addition, a valve system is introduced in the connecting duct, in order to adapt the damping characteristic to different driving situations.

An air spring damper of this type has the disadvantage, however, that a large amount of installation space is required as a result of the separate additional volume container. It is desirable for a compact overall design, however, to integrate the additional volume into the rolling piston. On account of the low amount of available installation space, it is not possible to design a rotationally symmetrical rolling piston which has a sufficient volume. Moreover, it is known to utilize the volume of the adjacent vehicle parts, such as a support arm or link, as additional volume. Solutions of this type are very expensive, however, since they require complex deep-drawn parts which have to be welded in a gastight manner.

The invention is therefore based on the object of providing a rolling piston for an air spring damper, which rolling piston has a large volume and a compact overall design and at the same time is inexpensive to produce.

### SUMMARY OF THE INVENTION

The rolling piston according to the invention comprises a piston section and a container section which are of hollow configuration and are connected to one another in a fluid-conducting manner, and a cover element. The cover element is connected to the container section, in order to form an additional volume container. On account of the integrated additional volume container, the rolling piston according to the invention has a compact overall design. In addition, the additional volume container is configured in such a way that a sufficiently large volume is made available for the function of an air spring damper. As a result of the integration of the additional volume container into the rolling piston, the latter is inexpensive to produce and additionally has a low weight. The additional volume container is advantageously integrated into the rolling piston in such a way that said additional volume container is arranged laterally adjacently with respect to the rolling piston. As a consequence of the lateral arrangement of the additional volume container, the rolling piston according to the invention has a low overall height. Furthermore, the additional volume container preferably extends in the axial direction parallel to the piston section.

The rolling piston is advantageously configured in one piece or one part with the piston section and the container section. Moreover, the two sections can also be produced separately from one another and subsequently connected to one another in a gastight manner.

In one advantageous refinement, the cover element is of hemispherical configuration. As a result, the additional volume container has a comparatively small surface area with a simultaneously large volume. Therefore, the ratio of surface area to volume of the additional volume container is comparatively low. As a result, the rolling piston according to the invention has a compact overall design with a simultaneously large volume.

Furthermore, the container section is advantageously of hollow-cylindrical configuration. The hollow-cylindrical refinement once again increases the volume of the additional volume container. In addition, the cover element can be fastened simply to the container section as a result.

In one advantageous refinement, a connector section is arranged between the piston section and the container section. Furthermore, the connector section advantageously has a supporting face for fastening the rolling piston to a vehicle part. The supporting face is advantageously directed outward, with the result that the rolling piston rests on a vehicle part by means of the supporting face. Furthermore, a fastening element, such as a fastening pin or bolt, is advantageously used for fastening purposes. The container section is preferably of longer configuration in the axial direction than the connector section. Here, the extended section of the container section can serve as a stop for positioning on a vehicle part.

The cover element is preferably connected to the rolling piston via a coupling device. Furthermore, the coupling device preferably comprises a fastening element which is connected by way of a first end to the rolling piston and by way of a second end to the cover element. In one advantageous refinement, the fastening element extends through the cover element, said fastening element bearing with its second end against a surface of the cover element. To this end, an opening or bore can be made in the cover element. A sealing element is advantageously arranged for sealing purposes between the fastening element and the opening. Furthermore, the fastening element is preferably configured as a hexagon bolt, the second end being provided with a bolt head and the first end being provided with a thread for screwing into the rolling piston. In one advantageous refinement, a washer is arranged between the second end of the fastening element and the surface of the cover element. As a result, the force which acts on the cover element is distributed to a greater area during screwing, with the result that damage of the cover element is avoided.

In a further advantageous refinement, the cover element is connected in an integrally joined manner to the container section, in particular is welded and/or adhesively bonded. The welded seam and/or the adhesive seam are/is advantageously of circumferential configuration. The welding preferably takes place by means of hot gas welding. In hot gas welding, the two components to be joined, in particular their joining region, are heated by hot gas and/or melted or plasticized and subsequently joined together under pressure. The heating or plasticization takes place without contact via hot gas in the hot gas welding. Nitrogen is advantageously used as the hot gas in the hot gas welding. As a result, the components are protected against oxidation and/or reaction during the heating or plasticization. As a result, the welded seam has a high strength.

Furthermore, the cover element is advantageously screwed to the container section. The cover element preferably has a first circumferential thread section and the container section has a second circumferential thread section which corresponds to it. Screwing together represents a joining method which is simple to handle and therefore inexpensive. Furthermore, the threads can already be made during the production of the cover element and the rolling piston or in a subsequent working operation.

In one advantageous refinement, a sealing ring is arranged between the cover element and the container section. A sealing ring is preferably used when the cover element is screwed into the container section. The sealing ring ensures a sufficient sealing action of the additional volume container. The sealing ring is advantageously configured as an O-ring. Sealing rings of this type are available as inexpensive mass produced items.

Furthermore, the cover element advantageously has a flange section, into which a free end of the container section engages. The flange section is advantageously configured as a circumferential recess. A circumferential groove is preferably made in the flange section, into which circumferential groove a projection which protrudes on the container section engages. As a result, a sufficient sealing action of the additional volume container is produced in the connecting region of the cover element and the container section.

In one advantageous refinement, the piston section is provided with a buffer/damper unit. The piston section preferably has an annular fastening section, into which the buffer/damper unit is introduced. In one advantageous refinement, the buffer/damper unit assumes the damping function. To this end, openings are made in the buffer/damper unit. During the compression and rebound, the fluid which is situated in the working space and the additional volume container flows to and fro via the openings, a damping action being generated on account of the frictional effect. The openings can additionally be provided with a valve in order to set a damping characteristic. The buffer/damper unit is preferably pressed into the fastening section. The annular fastening section is advantageously configured as a force fit. In order to reinforce the force fit, additional reinforcing elements can be introduced into the fastening section.

Furthermore, the buffer/damper unit can also be used to reinforce the force fit of the rolling piston. To this end, the buffer/damper unit is introduced into the rolling piston, in particular is pressed in, and subsequently a free end of an air spring bellows is clamped to the rolling piston by means of a clamping ring. Therefore, the buffer/damper unit absorbs the tensile and compressive loads of the air spring bellows during the compression and rebound. As a result, the rolling piston is loaded only by the internal pressure which prevails in the interior. The buffer/damper unit is advantageously configured as a separate unit which is pressed into the rolling piston in a subsequent working operation. Moreover, the buffer/damper unit can also be connected to the piston section in an integrally joined manner, for example by way of welding or adhesive bonding.

Furthermore, the buffer/damper unit advantageously has a valve plate and a buffer element. Via the valve plate, the fluid flows to and fro between the working space and the rolling piston or the additional volume container. To this end, openings with a small cross section are advantageously made in the valve plate, in order to achieve a frictional effect and, associated therewith, a damping action. The openings can be capable of being opened or closed by means of valves. The buffer element is advantageously arranged on the valve plate in such a way that it is assigned to the working space. The buffer serves as a stop for the rolling piston and therefore limits its movement in the axial direction.

In one advantageous refinement, the valve plate is provided with a support tube. The support tube is advantageously attached on a side of the valve plate which lies opposite the buffer and extends here through the piston section and the connector section in the mounted state of the buffer/damper unit. The support tube is advantageously supported on a side of the connector section which lies opposite the supporting face. The fastening of the rolling piston to a vehicle part preferably takes place via the support tube. To this end, a fastening element, such as a fastening pin or bolt, can be connected to the support tube. The support tube transmits the force which acts on the buffer directly to the vehicle part. The support tube therefore serves as a strength support for the buffer/damper unit. The support tube is advantageously connected to the valve plate in an integrally joined manner.

In one advantageous refinement, the rolling piston, preferably the piston section with a ring element, is provided with a rolling contour for rolling an air spring bellows. The ring element is preferably configured as a separate element which can be connected in a non-positive manner to the piston section, in particular the rolling section. Here, during compression of an air spring damper, an air spring bellows rolls on the rolling contour. The stiffness or the characteristic of the air spring damper can be set via the shape of the rolling contour. Therefore, the stiffness or the characteristic of an air spring damper can be set in an inexpensive way. The ring element is advantageously produced from plastic. The piston section is preferably of cylindrical configuration, with the result that the ring element can be simply pressed on. As a result, the rolling piston can be released easily. Furthermore, the ring element advantageously supports a clamping ring which is fastened to the rolling piston.

The rolling piston is preferably produced from a composite material, in particular from polyamide (PA) with glass fibers or polypropylene (PP) with glass fibers. As a result, the rolling piston has a high strength and, at the same time, a low weight. Furthermore, the rolling piston can be produced by means of injection molding. The cover element is preferably produced separately. Moreover, the rolling piston can also be produced from metal, in particular aluminum.

Furthermore, the surface of the rolling piston according to the invention can be provided with a ribbing formation, in order to increase its strength with respect to stone chipping. In addition, the inner face of the piston section, the connector section and/or the container section and the inner face of the cover element can be provided with a reinforcing structure. To this end, the reinforcing structure can have a multiplicity of reinforcing ribs which are integrally formed on the inner face of the sections or the cover element. In one advantageous refinement, the reinforcing ribs are configured as horizontal and vertical ribs which are arranged at equidistant spacings from one another.

Furthermore, the present invention relates to an air spring damper having a rolling piston according to the invention, an air spring bellows and a terminating element. The air spring bellows is preferably connected by way of a first free end to the rolling piston and by way of a second free end to the terminating element, in order to form a working space which is filled with fluid. The air spring bellows is advantageously fastened by means of a clamping ring to an outer face of the rolling piston and to an outer face of the terminating element. Furthermore, a buffer/damper unit is advantageously introduced into the rolling piston. The buffer/damper unit advantageously reinforces the force fit for fastening the air spring bellows. The air spring damper according to the invention is distinguished by the additional volume container which is integrated into the rolling piston. In particular, the hemispherical configuration of the cover element ensures a low ratio of surface area to volume. As a result, the air spring damper has a sufficiently large volume for the damping action and is additionally of compact construction. Moreover, the air spring damper according to the invention is inexpensive to produce on account of the integrated additional volume container and additionally has a low weight.

### BRIEF DESCRIPTION OF THE DRAWINGS

In the following text, the rolling piston according to the invention and the air spring damper according to the invention will be explained in greater detail using the appended diagrammatic drawings, in which:

FIG. 1 shows a perspective illustration of an air spring damper according to the invention with a rolling piston according to the invention according to a first embodiment,

FIG. 2 shows a longitudinal section through the air spring damper which is shown in FIG. 1,

FIG. 3 shows a perspective illustration of the rolling piston according to the invention according to the first embodiment,

FIG. 4 shows a longitudinal section through the rolling piston which is shown in FIG. 3,

FIG. 5 shows a perspective illustration of a buffer/damper unit,

FIG. 6 shows a longitudinal section through the buffer/damper unit which is shown in FIG. 5,

FIG. 7 shows a longitudinal section through an air spring damper according to the invention with a rolling piston according to the invention according to a second embodiment, and

FIG. 8 shows a perspective illustration of a rolling piston according to the invention according to a third embodiment.

### DETAILED DESCRIPTION OF THE PREFERRED EMBODIMENTS

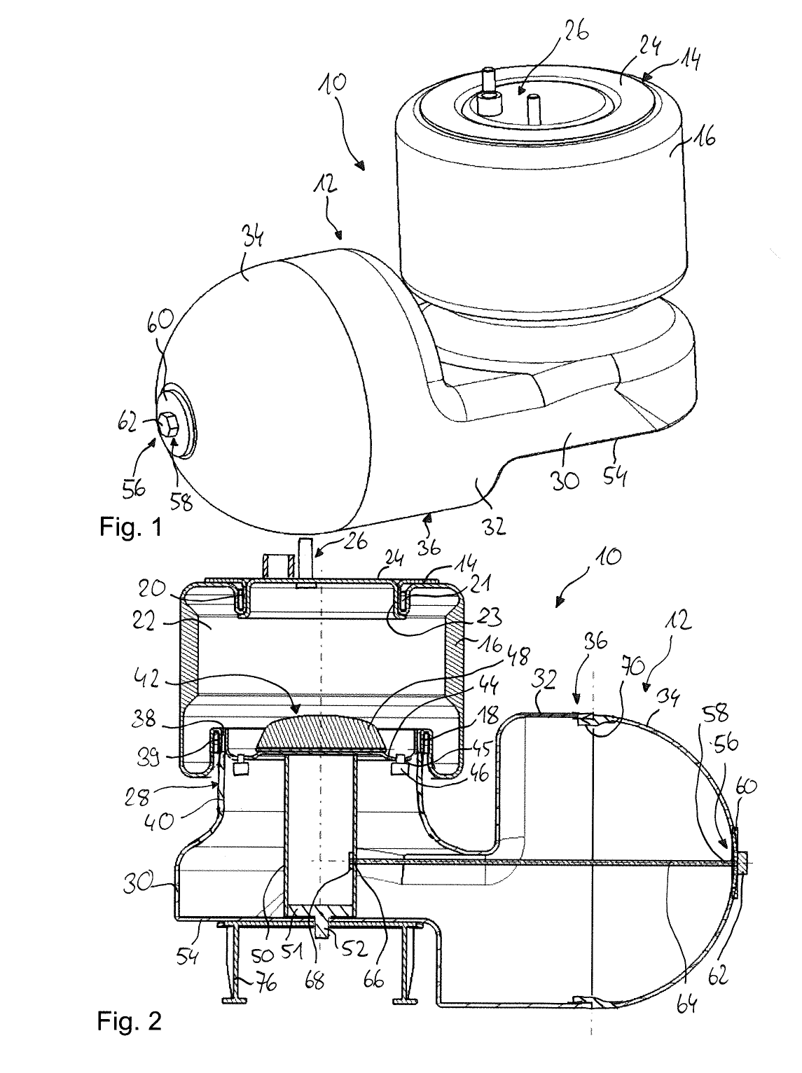

FIGS. 1 and 2 show an air spring damper 10 according to the invention which is arranged between a load-bearing part (not shown) and a link 76 of a commercial vehicle.

The air spring damper 10 has a rolling piston 12 according to the invention, a terminating element 14 and an air spring bellows 16. As shown, in particular, in FIG. 2, the air spring bellows 16 is connected at a first free end 18 to the rolling piston 12 and at a second free end 20 to the terminating element 14, in order thus to form a working space 22 which is filled with fluid.

In the present case, the terminating element 14 is configured as a plate with a collar section 23 for fastening the second end 20 and has a supporting section 24 for supporting a load-bearing part. The second end 20 is clamped to the collar section 23 by means of a clamping ring 21. Furthermore, the terminating element 14 is provided with a connector device 26 for connecting a fluid source (not shown). The pressure within the working space 22 can be changed via the connector device 26. Here, compressed air can be used as a fluid source. To this end, a compressed air hose (not shown) can be connected to the connector device 26.

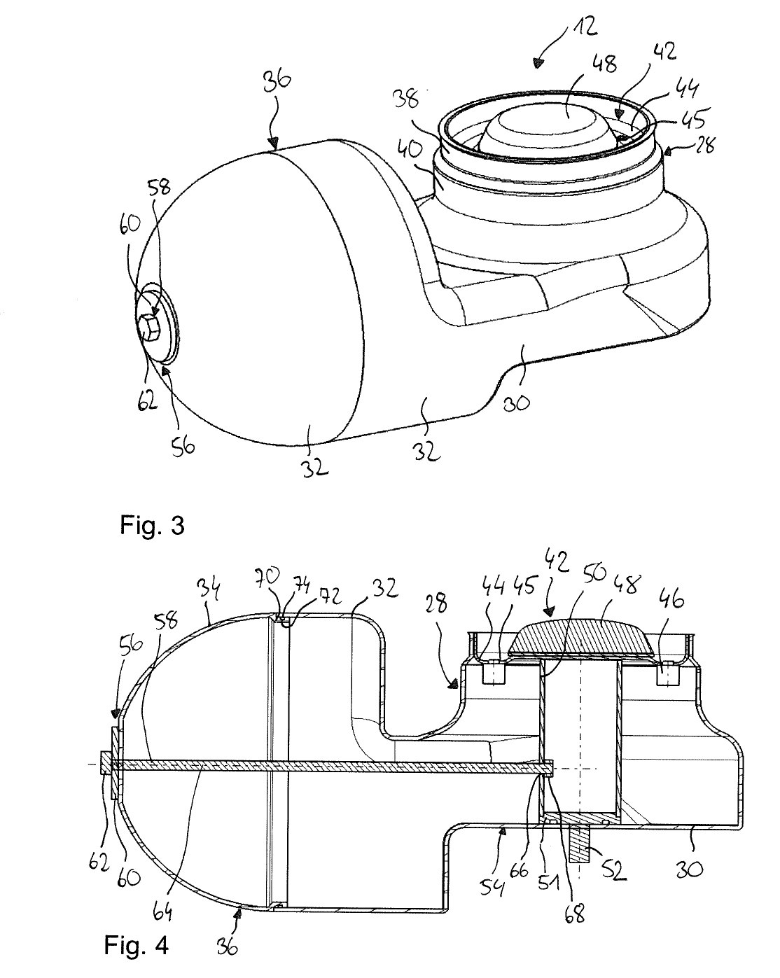

As can be seen, in particular, in FIGS. 2 to 4, the rolling piston 12 has a hollow-cylindrical piston section 28, a connector section 30, a container section 32 of approximately hollow-cylindrical configuration, and a hemispherical cover element 34. Here, the cover element 34 closes the container section 32, an additional volume container 36 with an additional volume being formed. The additional volume of the additional volume container 36 is connected in a fluid-conducting manner to the connector section 30 and the piston section 28.

The piston section 28 comprises an annular fastening section 38 and a rolling section 40, on the outer face of which the air spring bellows 16 can roll during compression and rebound. The second end 20 of the air spring bellows 16 is clamped by way of a clamping ring 39 on an outer side of the fastening section 38, as can be seen in FIG. 2. Furthermore, a buffer/damper unit 42 is introduced into the fastening section 38. The buffer/damper unit 42 reinforces the force fit for fastening the air spring bellows 16. Moreover, the buffer/damper unit 42 absorbs the tensile and compressive loads during compression and rebound. As a result, the rolling piston 12 is loaded only by the internal pressure.

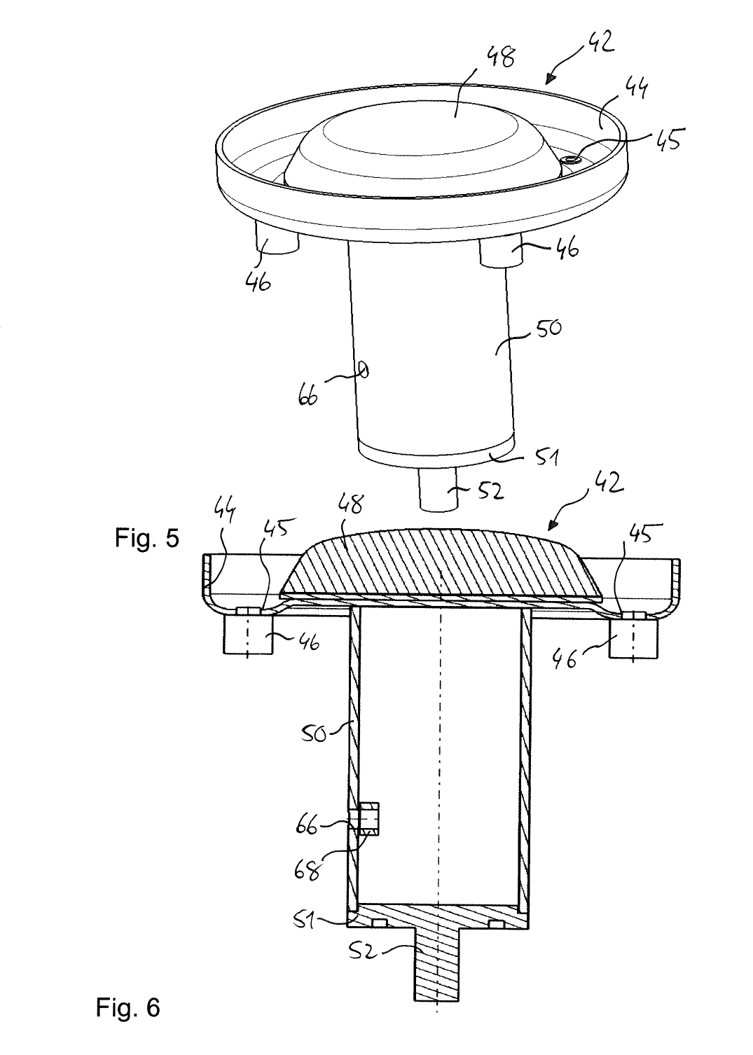

As can be seen in FIGS. 5 and 6, the buffer/damper unit 42 is configured as a separate unit which can be introduced, in particular can be pressed, into the fastening section 38. The buffer/damper unit 42 can also be connected to the fastening section 38 in an integrally joined manner by way of welding and/or adhesive bonding. The buffer/damper unit 42 has a valve plate 44 with openings 45 which are made therein, a buffer 48 and a support tube 50. The openings 45 can be opened and closed by means of valves 46. Via the openings 45 and the valves 46, the fluid which is situated in the working space 22 and in the rolling piston 12 or the additional volume container 36 flows to and fro during compression and rebound. Since the openings 45 have a comparatively small cross section, a damping action occurs during the compression and rebound on account of the frictional effect. The buffer 48 serves as a stop during an axial movement of the rolling piston 12 and therefore limits the axial deflection of the rolling piston 12. The support tube 50 is connected fixedly to the valve plate 44 and extends through the piston section 28 and the connector section 30. In addition, the support tube 50 is provided on the end side with a base plate 51, by means of which it is supported on a base of the connector section 30. The base plate 51 has a threaded bolt 52, via which the fastening of the rolling piston 12 to a link 76 of a commercial vehicle takes place, as shown in FIG. 2.

The fastening of the cover element 34 to the rolling piston 12 takes place via a coupling device 56, as shown in FIGS. 2 and 4. To this end, the coupling device 56 has a hexagon bolt 58 and a washer 60. Here, a bolt head 62 of the hexagon bolt 58 bears against a surface of the cover element 34, a bolt shank 64 extending through an opening which is made in the cover element 34. A sealing element (not shown) is arranged between the opening and the bolt shank 64. The bolt shank 64 is provided on the end side with a thread which extends through a bore 66 which is made in the support tube 50. The bore 66 is surrounded by a nut 68 which is connected fixedly to the support tube 50. In order to fasten the hexagon bolt 58, the thread of the bolt shank 64 is screwed into the nut 68. The washer 60 is arranged between the cover element 34 and the bolt head 62. In order to provide a sufficient supporting face for the washer 60, the cover element 34 is of flattened configuration in the region of the opening. Furthermore, the cover element 34 has a circumferential flange section 70 which is configured as a recess in the present case. Here, the free end of the container section 32 lies in the flange section 68. In order to provide a sufficient gastight sealing action, the flange section 70 has a circumferential groove 72, into which a projection 74 which is configured circumferentially at the free end of the container section 32 engages.

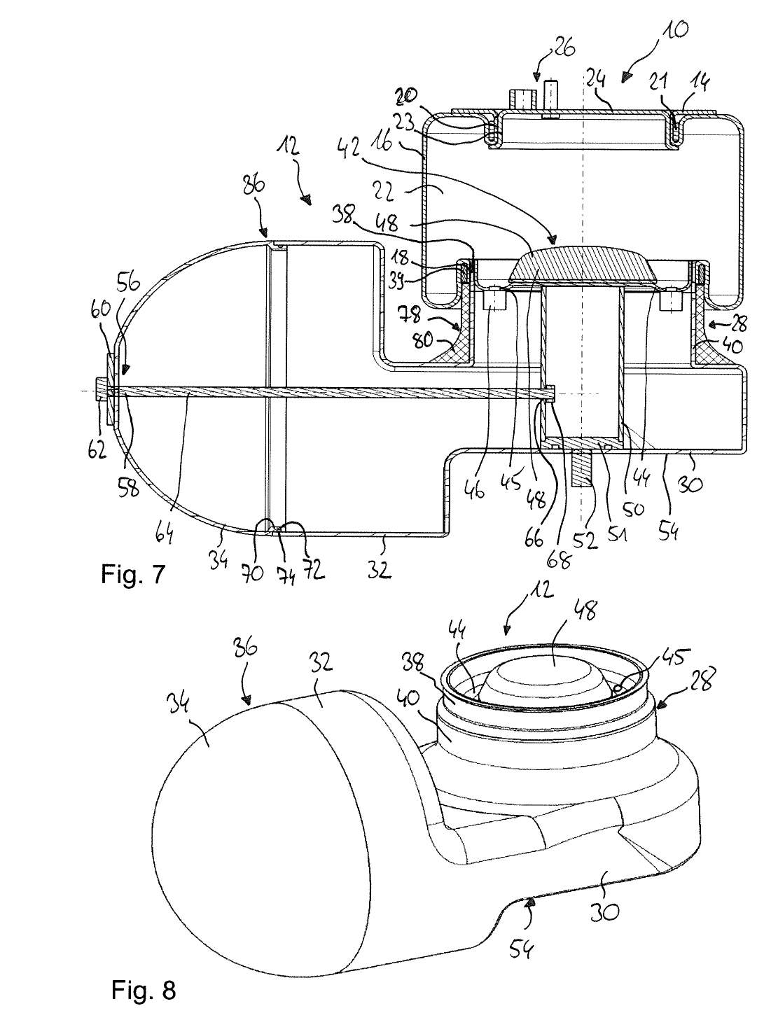

FIG. 7 shows a second embodiment of a rolling piston 12 according to the invention which differs from the first embodiment in that the piston section 28, in particular the rolling section 40 with a ring element 78, is provided with a rolling contour 80. Here, the ring element 78 is a separate element which is produced from plastic and is connected in a non-positive manner to the piston section 40, in particular the rolling section 40. The ring element 78 is preferably pressed onto the piston section 28, in particular the rolling section 40. During compression of the air spring damper 10, the air spring bellows 16 rolls on the radius of the rolling contour 80. The stiffness or the characteristic of the air spring damper 10 can be set via the shape of the rolling contour 80. Therefore, the stiffness or the characteristic of the air spring damper 10 can be set in an inexpensive way. Furthermore, the ring element 78 serves for axial fixing of the clamping ring 39.

FIG. 8 shows a third embodiment of a rolling piston 12 according to the invention which differs from the first and second embodiment in that the cover element 34 is connected to the container section 32 in an integrally joined manner, in particular by way of a circumferential welded and/or adhesive seam.

In a further alternative embodiment, the cover element 34 can be connected to the container section 32 via a screw connection. To this end, the cover element 34 has a first thread section and the container section 32 has a second thread section which corresponds to it and into which the first thread section can be screwed. A sealing ring is arranged for sealing purposes between the cover element 34 and the container section 32.

The rolling piston 12 according to the invention is produced from a composite material, in particular from polyamide (PA) with glass fibers or polypropylene (PP) with glass fibers using the injection molding process. Furthermore, it is also conceivable to produce the rolling piston 12 from metal.

The air spring damper 10 according to the invention is distinguished by the rolling piston 12 according to the invention which has an integrated additional volume in the form of an additional volume container 36. On account of the hemispherical cover element 34, the ratio of surface area to volume of the additional volume container 36 is comparatively low. As a result, the rolling piston 12 has a sufficiently large volume for damping, and a compact overall design.

### LIST OF DESIGNATIONS

10 Air spring damper
12 Rolling piston
14 Terminating element
16 Air spring bellows
18 First free end
20 Second free end
21 Clamping ring
22 Working space
23 Collar section
24 Supporting section
26 Connector device
28 Piston section
30 Connector section
32 Container section
34 Cover element
36 Additional volume container
38 Fastening section
39 Clamping ring
40 Rolling section
42 Buffer/damper unit
44 Valve plate
45 Opening
46 Valve
48 Buffer
50 Support tube
51 Base plate
52 Threaded bolt
54 Supporting face
56 Coupling device
58 Hexagon bolt
60 Washer
62 Bolt head
64 Bolt shank
66 Bore
68 Nut
70 Flange section
72 Groove
74 Projection
76 Link
78 Ring element
80 Rolling contour

1.-15. (canceled)

16. A rolling piston for an air spring damper for a commercial vehicle comprising:
a piston section;
a container section, wherein the piston section and the container section each have a hollow configuration and are connected to one another in a fluid-conducting manner; and
a cover element connected to the container section to form an additional volume container, wherein and the piston section includes a buffer/damper.

17. The rolling piston as claimed in claim 16, wherein the cover element comprises a hemispherical configuration.

18. The rolling piston as claimed in claim 16, wherein the container section comprises a hollow-cylindrical configuration.

19. The rolling piston as claimed in claim 16, further comprising:
a connector section arranged between the piston section and the container section.

20. The rolling piston as claimed in claim 16, wherein the cover element is connected to the rolling piston via a coupling device.

21. The rolling piston as claimed in claim 20, wherein the coupling device comprises a fastening element which is connected by way of a first end to the rolling piston and by way of a second end to the cover element.

22. The rolling piston as claimed in claim 16, wherein the cover element is integrally connected to the container section.

23. The rolling piston as claimed in claim 22, wherein the cover element is connected to the container section via at least one of a weld and an adhesive bond.

24. The rolling piston as claimed in claim 16, wherein the cover element is screwed to the container section.

25. The rolling piston as claimed in claim 16, further comprising:
a sealing ring that is arranged between the cover element and the container section.

26. The rolling piston as claimed in claim 16, wherein the buffer/damper unit includes a valve plate and a buffer element.

27. The rolling piston as claimed in claim 26, wherein the valve plate includes a support tube.

28. The rolling piston as claimed in claim 16, wherein the rolling piston includes a rolling contour for rolling an air spring bellows.

29. The rolling piston as claimed in claim 28, wherein the piston section with a ring element of the rolling piston includes the rolling contour.

30. The rolling piston as claimed in claim 16, wherein the rolling piston comprises a composite material.

31. The rolling piston as claimed in claim 30 comprises at least one of a polyamide with glass fibers and polypropylene with glass fibers.

32. The rolling piston as claimed in claim 16, wherein the piston section and the container section are one piece.

33. The rolling piston as claimed in claim 16, wherein the connector section has a supporting face configured to fasten the rolling piston to a vehicle part.
